(19) United States
(12) Patent Application Publication
(10) Pub. No.: US 2026/0358980 A1
(43) Pub. Date: Nov. 12, 2026

(54) DATA PROCESSING METHOD AND ELECTRONIC DEVICE

(71) Applicant: CLOUD INTELLIGENCE ASSETS HOLDING (SINGAPORE) PRIVATE LIMITED, Singapore (SG)

(72) Inventors: Xingxuan ZHOU, Hangzhou City (CN); Junbin KANG, Hangzhou City (CN); Le CAI, Cupertino, CA (US); Feifei LI, Hangzhou City (CN)

(21) Appl. No.: 19/153,568

(22) PCT Filed: Feb. 22, 2024
(86) PCT No.: PCT/CN2024/078157

§ 371 Date: Aug. 4, 2025

(30) Foreign Application Priority Data
Mar. 3, 2023 (CN) 202310218978.4

(51) Int. Cl. G06F 3/06; G06F 16/23

(52) U.S. Cl. CPC G06F 3/0656; G06F 3/0608; G06F 3/0659; G06F 3/0674; G06F 16/2343

(57) ABSTRACT

Embodiments of the present application provide a data processing method and an electronic device. The method includes: in response to a first database operation instruction, determining a first buffer page group in a buffer pool of a database, where the first buffer page group includes a plurality of associated buffer pages; and compressing data in the plurality of buffer pages in the first buffer page group, and writing the compressed data into a disk. This increases a compression ratio and saves disk space.

The present application claims priority to Chinese Patent Application No. 202310218978.4, filed with the China National Intellectual Property Administration on Mar. 3, 2023 and entitled “DATA PROCESSING METHOD AND ELECTRONIC DEVICE”, which is incorporated by reference in its entirety.

### TECHNICAL FIELD

The present application relates to the field of databases, and more specifically, to a data processing method and an electronic device.

### BACKGROUND

A database stores data such as tuples (tuples) and indexes of a table on a disk by page, and the data is read and written by page. To increase an access speed, data caching is performed in the database by using a buffer pool (Buffer Pool) in an internal memory. The buffer pool includes a plurality of buffer pages (Buffer Pages), and data cached in each buffer page corresponds to a page in the disk.

The data cached in the buffer pool is evicted into the disk by using a buffer page as a unit or is loaded from the disk by using a buffer page as a unit. For each buffer page, when data is evicted into the disk, the data may be compressed and stored into the disk, to save disk space. Correspondingly, when data is loaded from the disk into a buffer page, the compressed data in the disk is decompressed and then loaded into the buffer page. As a size of the buffer page (page size) is set to a fixed value, and minimum occupied physical space on the disk is also fixed, the size of the buffer page directly affects a compression ratio, and a set size of the buffer page may not satisfy a requirement of a user for a high compression ratio.

### SUMMARY

The present application provides a data processing method and an electronic device, to increase a compression ratio and save disk space.

According to a first aspect, the present application provides a data processing method, including:
in response to a first database operation instruction, determining a first buffer page group in a buffer pool of a database, where the first buffer page group includes a plurality of associated buffer pages; and
compressing data in the plurality of buffer pages in the first buffer page group, and writing the compressed data into a disk.

Optionally, before the compressing data in the plurality of buffer pages in the first buffer page group, and writing the compressed data into a disk, the method further includes:
sequentially acquiring input/output IO locks on the plurality of buffer pages in a sequence of pages corresponding to the plurality of buffer pages in the first buffer page group;
after the compressing data in the plurality of buffer pages in the first buffer page group, and writing the compressed data into a disk, the method further includes:
sequentially releasing the IO locks on the plurality of buffer pages in a reverse sequence of the pages corresponding to the plurality of buffer pages in the first buffer page group.

Optionally, the method further includes:
for each buffer page, acquiring an exclusive lock on the buffer page in a buffer table of the buffer pool in the sequence of the pages corresponding to the plurality of buffer pages in the first buffer page group; when the exclusive lock is successfully acquired, acquiring a spinlock on buffer description information of the buffer page; when the spinlock is successfully acquired, determining whether the buffer page is a dirty page; and if none of the plurality of buffer pages in the first buffer page group is a dirty page, deleting the buffer description information of the plurality of buffer pages in the first buffer page group, releasing the spinlocks on the plurality of buffer pages in the first buffer page group, deleting records related to the plurality of buffer pages in the first buffer page group from the buffer table, and releasing the exclusive locks on the plurality of buffer pages in the first buffer page group.

Optionally, the method further includes:
if an exclusive lock or a spinlock fails to be acquired on any buffer page in the first buffer page group, determining a second buffer page group in the buffer pool of the database, where the second buffer page group includes a plurality of buffer pages; and
compressing data in the plurality of buffer pages in the second buffer page group, and writing the compressed data into the disk.

Optionally, the first buffer page group includes a first buffer page and at least one second buffer page, and the determining a first buffer page group in a buffer pool of a database includes:
determining the first buffer page in the buffer pool of the database; and
determining the second buffer page in the buffer pool of the database based on an association relationship between the first buffer page and the second buffer page.

Optionally, the method further includes:
in response to a second database operation instruction, determining a third buffer page group in the buffer pool, where the third buffer page group includes a plurality of associated buffer pages; and
decompressing data that is in the disk and that is of a page corresponding to the second database operation instruction, and loading the decompressed data into the plurality of buffer pages in the third buffer page group.

Optionally, the third buffer page group includes a third buffer page corresponding to the second database operation instruction and at least one fourth buffer page associated with the third buffer page;
the determining a third buffer page group in the buffer pool includes:
determining the third buffer page in the buffer pool; and
determining the fourth buffer page in the buffer pool based on an association relationship between the third buffer page and the fourth buffer page.

Optionally, the method further includes:
sequentially acquiring IO locks on the plurality of buffer pages in the third buffer page group in a sequence of pages corresponding to the plurality of buffer pages in the third buffer page group.

Optionally, the sequentially acquiring IO locks on the plurality of buffer pages in the third buffer page group in a sequence of pages corresponding to the plurality of buffer pages in the third buffer page group includes:
after determining the third buffer page in the buffer pool, acquiring an IO lock on the third buffer page; and
if a page corresponding to the third buffer page is a first page in the pages corresponding to the plurality of buffer pages in the third buffer page group, after determining the fourth buffer page in the buffer pool, continuing to acquire an IO lock on the fourth buffer page based on a sequence of a page corresponding to the fourth buffer page; or
if a page corresponding to the third buffer page is not a first page in the pages corresponding to the plurality of buffer pages in the third buffer page group, releasing the IO lock on the third buffer page, and after determining the fourth buffer page in the buffer pool, sequentially acquiring the IO locks on the plurality of buffer pages in the third buffer page group in the sequence of the pages corresponding to the plurality of buffer pages in the third buffer page group.

Optionally, after the decompressing data that is in the disk and that is of a page corresponding to the second database operation instruction, and loading the decompressed data into the plurality of buffer pages in the third buffer page group, the method further includes:
sequentially releasing the IO locks on the plurality of buffer pages in the third buffer page group in a reverse sequence of the pages corresponding to the plurality of buffer pages in the third buffer page group.

Optionally, the method further includes:
in response to a third database operation instruction, determining a fifth buffer page in the buffer pool; and
compressing data in the fifth buffer page, and writing the compressed data into the disk.

Optionally, the method further includes:
in response to a fourth database operation instruction, determining a sixth buffer page in the buffer pool; and
decompressing data that is in the disk and that is of a page corresponding to the fourth database operation instruction, and loading the decompressed data into the sixth buffer page.

According to a second aspect, the present application provides an electronic device, including a memory and a processor;
the memory is configured to store a computer program; and
the processor is configured to execute the computer program stored in the memory, and when the computer program is run, the processor is enabled to perform the method according to the first aspect.

According to a third aspect, the present application provides a computer-readable storage medium. The computer-readable storage medium stores a computer program, and when the computer program is executed by a processor, the processor is enabled to perform the method according to the first aspect.

In the data processing method and electronic device provided in the present application, a plurality of buffer pages may be bound to form a buffer page group, an IO unit of a buffer pool is extended by using the buffer page group. The plurality of buffer pages in the buffer page group undergo data loading and data eviction collectively. During data eviction, after data in the plurality of buffer pages undergoes compression collectively, the compressed data is written into a disk. The plurality of buffer pages are compressed together, so that a compression ratio is increased, and disk space is saved.

### BRIEF DESCRIPTION OF DRAWINGS

To describe the technical solutions in embodiments of the present application or in conventional technologies more clearly, the accompanying drawings required for describing embodiments or conventional technologies are briefly described below. Apparently, the accompanying drawings in the following description show some embodiments of the present application, and a person of ordinary skill in the art may still obtain other drawings from these accompanying drawings without paying creative efforts.

FIG. 1 is a schematic diagram of writing data into a disk.

FIG. 2 is a schematic diagram of a principle of a buffer page group according to an embodiment of the present application.

FIG. 3 is a schematic flowchart of a data processing method according to an embodiment of the present application.

FIG. 4 is a schematic diagram of data loading for a buffer page group according to an embodiment of the present application.

FIG. 5 is a schematic diagram of data eviction for a buffer page group according to an embodiment of the present application.

FIG. 6 is a schematic block diagram of an electronic device according to an embodiment of the present application.

### DESCRIPTION OF EMBODIMENTS

To make objectives, technical solutions, and advantages of embodiments of the present application clearer, the technical solutions in embodiments of the present application are clearly and completely described below with reference to the accompanying drawings in embodiments of the present application. Apparently, the described embodiments are some rather than all of embodiments of the present application. All other embodiments obtained by a person of ordinary skill in the art based on embodiments of the present application without creative efforts shall fall within the protection scope of the present application.

First, terms in embodiments of the present application are described briefly.

Buffer pool: the buffer pool is a region in an internal memory, and is used to buffer data of a database, for example, tables and indexes.

Disk page: a database stores data, for example, tables and indexes, on a disk by pages.

Buffer page: a buffer pool includes a plurality of buffer pages. Data cached in each buffer page corresponds to a disk page. A size of the buffer page may be set. For example, a size of a buffer page is 8 KB.

Transparent compression: data is written into a file system after compression, and a file hole mechanism provided by the file system (for example, ext4 and xfs) is used to save disk space. Transparent means that the process is not perceived by an upper-layer application. Works of saving disk space are completed by the file system, and the upper-layer application only needs to perform compression.

Table: a relational database stores data in a logical form of a table.

Compression ratio: the compression ratio is a ratio of a size of a file after compression to a size of the file before compression. For example, if a 100 MB file is compressed to 90 MB, the compression ratio is 90/100*100%=90%. A smaller value of the compression ratio indicates a higher compression ratio.

File system block size (block size): the file system block size is a size of minimum occupied physical space on a disk, and is usually 4 KB. For example, an actual size of a file is 5 KB, but the file occupies 8 KB of disk space.

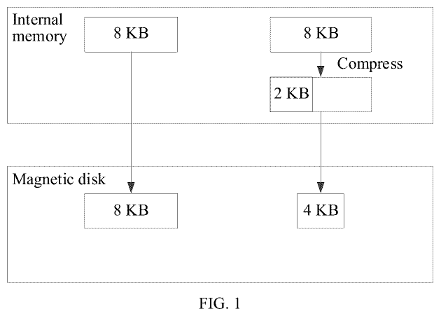

Transparent compression is further described first. For transparent compression, a feature that a hole in a mainstream file system does not actually occupy disk space is used. A hole is created at a tail of a file through compression, and the hole portion in a file system does not occupy disk storage. As shown in FIG. 1, when compression is not performed, 8 KB of data in an internal memory is written into a file system (where the file system is responsible for persistence), and the data occupies 8 KB of space on a disk. However, when data of 8 KB in the internal memory is written into the file system after compression, the data of 8 KB is compressed to 2 KB, leaving a 6 KB hole. The hole portion does not occupy actual disk space when being written into the file system. However, because a file system block size is 4 KB, in other words, at least 4 KB is occupied each time, the compressed data finally occupies 4 K of disk space. It can be learned that using transparent compression can save disk space occupation and reduce storage costs.

For a database, operations such as creation, deletion, and modification of data are all performed in a buffer page. During data writing, data is first written into a buffer page, and the data in the buffer page is evicted into a disk according to a cache eviction mechanism. When data is read from a disk, compressed data is decompressed, and the decompressed data is loaded into a buffer page. When a buffer page is to be evicted and written into a disk, with reference to the foregoing transparent compression function, an objective of saving disk space can be conveniently achieved. When a page needs to be read from a disk into a buffer page, compressed data is obtained from a file system and decompressed in an internal memory, and the decompressed data is loaded into the buffer page.

Buffer pages in a buffer pool have a same size, and a size of a buffer page directly affects a compression ratio. For example, when the size of a buffer page is 8 KB, assuming that data can be compressed to 25% of its original size according to a compression algorithm, the 8 KB buffer page is compressed to 2 KB. However, because a file system block size is 4 KB, final occupied disk space is still 4 KB, and an actual value of compression ratio is 50%. When a size of a buffer page is 16 KB, assuming that the foregoing compression algorithm is used, the 16 KB buffer page is compressed to 4 KB. When a file system block size is 4 KB, final occupied disk space is 4 KB, and a value of compression ratio is 25%. In comparison with the compression ratio when a size of a buffer page is 8 KB, the compression ratio is doubled.

It can be learned that a larger size of a buffer page indicates a higher compression ratio. To obtain a higher compression ratio, the size of a buffer page may be set to a larger value. However, it should be noted that the size of the buffer page may also affect database performance. This is because a larger buffer page indicates that input/output (Input/Output, IO) amplification caused by data reading or data modification affects the database performance. In addition, a larger buffer page indicates impact on more data when the entire page is locked. When buffer pages have a same size, a high compression ratio for a part of tables and high performance for a part of tables cannot be achieved at the same time.

To resolve the foregoing problem, a multi buffer pool (multi buffer pool) solution is provided in related technologies. During running of a database instance (instance), there are multiple buffer pool instances. Buffer pages in each buffer pool have a same size. However, sizes set for buffer pages in different buffer pools are different. When a page needs to be used, a buffer pool to which the page belongs is calculated based on page information, and searching and processing are performed in a corresponding buffer pool. However, this solution relates to management of multiple buffer pools, resulting in an increase in management overheads and processing complexity.

In view of this, embodiments of the present application provide a data processing method based on a single buffer pool. For a table requiring a high compression ratio, a plurality of buffer pages may be bound to form a buffer page group (group). An IO unit of a buffer pool is extended based on a logical concept of the buffer page group, to provide an IO capability of a single buffer page multiplied by different multiples, and this is equivalent to increasing a size of a buffer page by multiple times. A plurality of buffer pages in a buffer page group undergo data loading and data eviction collectively. During data eviction, after data in the plurality of buffer pages undergoes transparent compression collectively, the compressed data is written into a disk. The plurality of buffer pages are compressed together, so that a compression ratio is increased. During data loading, the compressed data in the disk is decompressed, and the decompressed data is written into the plurality of buffer pages in the buffer page group.

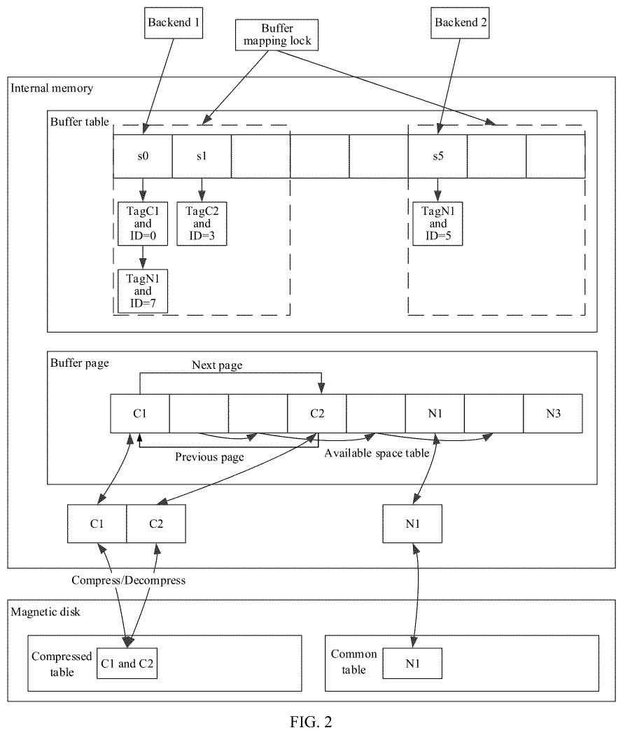

As shown in FIG. 2, a backend (backend) 1 and a backend 2 are processes (corresponding to a user SQL request) that execute a structured query language (Structured Query Language, SQL), and a buffer table (Buffer Table) is a hash (hash) table. The buffer table stores a correspondence between a page identifier (page id) and a buffer page location, which is used for quickly finding, based on a page identifier, a location of a buffer page corresponding to a page in a buffer pool. For example, s0, s1, and s5 in the figure represent slots (slots) in a bucket (Bucket), and the slots store page identifiers and buffer page locations. TagC1, TagC2, TagN1, and TagN3 are the page identifiers, which respectively represent pages C1, C2, N1, and N3. ID=0, ID=3, ID=5, and ID=7 respectively represent the buffer page locations corresponding to the pages C1, C2, N1, and N3. The buffer table may be divided into a plurality of regions, which are shown by dashed line boxes in FIG. 2. Page identifiers and buffer page locations are stored in slots in a bucket of a corresponding region. The acquisition of an exclusive lock on a buffer page in the buffer table is performed by region, and the exclusive lock is a buffer mapping lock (BufMappingLock). A buffer page array is a specific implementation form of the buffer pool. A free buffer page is linked through an available space table (freelist). A plurality of buffer pages in a buffer page group, for example, two buffer pages corresponding to the pages C1 and C2 in FIG. 2, are linked through a double-linked list. When a buffer page is read from/written into a disk, compression or decompression may be performed depending on whether a table is compressed. The disk may include a compressed table and a common table. The common table is a table that is stored in the disk without being compressed. For example, in FIG. 2, a buffer page group corresponding to the pages C1 and C2 is written into a disk after transparent compression, and a buffer page corresponding to the page N1 is directly written into the disk without compression.

In embodiments of the present application, a cache read/write strategy of each table is defined in a dimension of table. When creating a table, a user may specify a quantity of pages required by the table as an IO unit, and two or more pages being specified as an IO unit means that the table is a multi-page read/write table. In other words, a plurality of adjacent pages in a disk are used as a group. The group including the plurality of pages may be referred to as a page group, and the pages in the group may be referred to as sibling pages. A plurality of sibling pages are loaded together from the disk into a plurality of corresponding buffer pages in a buffer pool, and are evicted together from the plurality of buffer pages in the buffer pool into the disk. The plurality of buffer pages corresponding to the page group in the disk are a buffer page group. Using two pages as an example, the two pages are evicted together from two buffer pages in a buffer pool into a disk, and are loaded together from the disk into the two corresponding buffer pages in the buffer pool. There is no such case in which one page is in the buffer pool while the other page is not in the buffer pool. For a single-page read/write table, one page is still used as an IO unit for data loading or data eviction. A plurality of buffer pages are bound, so that a high compression ratio is achieved without affecting performance of a table that requires high performance. In this way, both the high compression ratio and the high performance are achieved.

In a buffer pool, a single buffer page is used as a basic management unit, and operations such as lock acquisition, searching, eviction, and loading of a buffer page are performed based on a single buffer page. However, when a multi-page read/write table is involved, the buffer page links a sibling page in a same buffer page group through a double-linked list, and loading or eviction of a plurality of buffer pages in the buffer page group is bound. For example, in a multi-page read/write table where two pages are used as an IO unit, two consecutive pages in a file system form a page group, and the two pages are read and decompressed together and are decompressed to two corresponding buffer pages in the buffer pool. Buffer page allocation is requested twice according to a single-buffer-page allocation algorithm, and two buffer pages are finally obtained. Therefore, two buffer pages in the buffer pool are not necessarily consecutive internal memories, and only a double-linked list needs to be used to quickly locate a sibling buffer page. During data loading and data eviction, lock acquisition and lock releasing of a buffer page are performed at a granularity of a single buffer page. The lock acquisition of a buffer page group is considered complete only after locks on all buffer pages included in the buffer page group have been acquired, and the lock releasing of a buffer page group is considered complete only after locks on all the buffer pages included in the buffer page group are released. During data loading, a first page in a plurality of pages is used as a reference. If it is determined that the first page has been loaded, all pages in the entire page group are considered to be fully loaded.

In the following, a data processing method provided in embodiments of the present application will be described in detail with reference to the accompanying drawings.

FIG. 3 is a schematic flowchart of a data processing method according to an embodiment of the present application. As shown in FIG. 3, the method includes the following steps.

S301: In response to a first database operation instruction, determine a first buffer page group in a buffer pool of a database, where the first buffer page group includes a plurality of associated buffer pages.

S302: Compress data in the plurality of buffer pages in the first buffer page group, and write the compressed data into a disk.

The first database operation instruction may be a cache eviction instruction from a database backend, or the first database operation instruction may be a user SQL request. Assuming that the user SQL request is for any operation such as any of creation, deletion, and modification, a to-be-operated page needs to be read into the buffer pool. If there is no free buffer page in the buffer pool, cache eviction needs to be performed. When cache eviction needs to be performed, a buffer page is determined as an eviction page in the buffer pool according to an eviction algorithm. If the eviction page has an associated buffer page, in other words, the eviction page belongs to the first buffer page group, in this case, the plurality of associated buffer pages, that is, the first buffer page group, all need to be evicted. For example, the first buffer page group includes a first buffer page and at least one second buffer page. The first buffer page is determined in the buffer pool of the database in response to the first database operation instruction. The second buffer page is determined in the buffer pool of the database based on an association relationship between the first buffer page and the second buffer page. Subsequently, after transparent compression is performed on the data in the plurality of buffer pages in the first buffer page group, the compressed data is written into the disk, to achieve a high compression ratio.

In the foregoing embodiment, when data is evicted from a buffer page into the disk, the plurality of associated buffer pages are compressed together and then written into the disk. When data is loaded from the disk into a buffer page, a third buffer page group is determined in the buffer pool in response to a second database operation instruction. The third buffer page group includes a plurality of associated buffer pages. Data that is in the disk and that is of a page corresponding to the second database operation instruction is decompressed and then loaded into the plurality of buffer pages in the third buffer page group.

The second database operation instruction may be a data reading instruction from the database backend, or the second database operation instruction may be a user SQL request. A page targeted by the second database operation instruction is a page of a multi-page read table. Therefore, buffer pages determined in response to the second database operation instruction are the plurality of associated buffer pages included in the third buffer page group. For example, the third buffer page group includes a third buffer page corresponding to the second database operation instruction and at least one fourth buffer page associated with the third buffer page. The third buffer page is determined in the buffer pool in response to the second database operation instruction. The fourth buffer page is determined in the buffer pool based on an association relationship between the third buffer page and the fourth buffer page. After the plurality of buffer pages are determined, the data of the page corresponding to the second database operation instruction is decompressed and then loaded to the plurality of buffer pages in the third buffer page group, to realize binding of a plurality of buffer pages in a buffer page group during data loading.

During data loading and data eviction of a buffer page, lock acquisition and lock releasing are performed on the buffer page. Descriptions are provided below with reference to processes of data loading and data eviction.

During use of the database, a plurality of processes may access different sibling pages in a same page group. Before a page is loaded from the disk into a buffer page, the buffer page needs to be allocated first, and the buffer page needs to be locked to prevent another process from reading dirty data. In embodiments of the present application, a sequence in which lock acquisition is performed on pages in a page group is controlled, and lock acquisition is performed in ascending order of the pages, to avoid a deadlock. For example, for the third buffer page group in the foregoing embodiment, before the data is loaded to the plurality of buffer pages in the third buffer page group, IO locks (Buffer IO locks) are sequentially acquired on the plurality of buffer pages in the third buffer page group in a sequence of pages corresponding to the plurality of buffer pages in the third buffer page group.

Optionally, an example in which the third buffer page group includes the third buffer page corresponding to the second database operation instruction and the at least one fourth buffer page associated with the third buffer page is used. After the third buffer page is determined in the buffer pool, an IO lock is acquired on the third buffer page. If a page corresponding to the third buffer page is a first page in the pages corresponding to the plurality of buffer pages in the third buffer page group, after the fourth buffer page is determined in the buffer pool, an IO lock is continued to be acquired on the fourth buffer page based on a sequence of a page corresponding to the fourth buffer page. If a page corresponding to the third buffer page is not a first page in the pages corresponding to the plurality of buffer pages in the third buffer page group, the IO lock on the third buffer page is released, and after the fourth buffer page is determined in the buffer pool, the IO locks are sequentially acquired on the plurality of buffer pages in the third buffer page group in the sequence of the pages corresponding to the plurality of buffer pages in the third buffer page group.

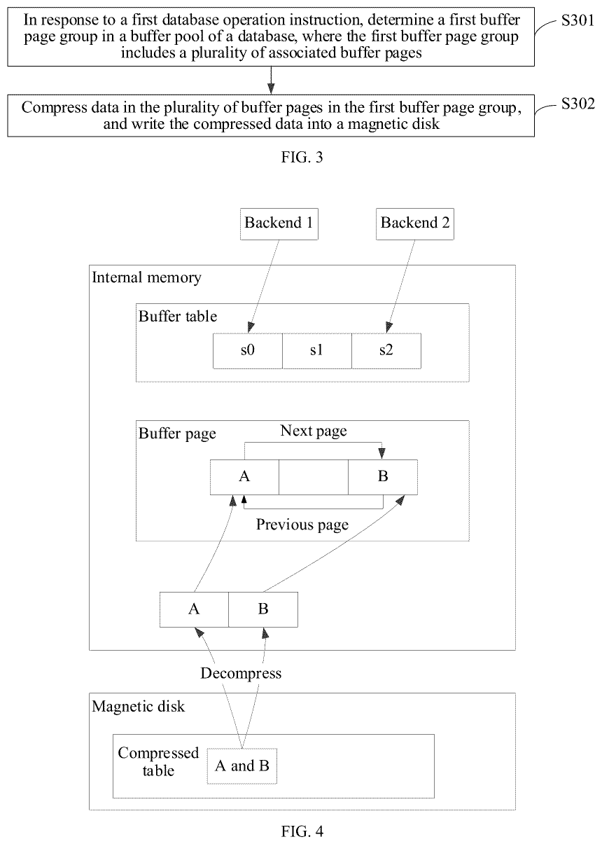

Descriptions are provided below with reference to FIG. 4. As shown in FIG. 4, it is assumed that a page A and a page B are two pages belonging to one page group. The page A is a previous page, the page B is a next page, and two buffer pages corresponding to the page A and the page B form the third buffer page group. It is assumed that a backend 1 needs to read the page A, a backend 2 needs to read the page B, and the page A and the page B have no corresponding buffer pages in the buffer pool. In this case, the page A and the page B need to be loaded from the disk into buffer pages. It is assumed that in an occurrence sequence of events, the backend 1 needs to read the page B first, and finds that the page B is not in the buffer pool, and therefore, the backend 1 allocates a corresponding buffer page to the page B, and acquires an IO lock on the buffer page, where the IO lock is an exclusive lock. Because of an association relationship between the page B and the page A, the backend 1 further needs to load the page A into the buffer pool, and therefore, a buffer page needs to be allocated to the page A. However, at the moment, the backend 2 reads the page A, and finds that the page A is not in the buffer pool. The backend 2 just preemptively allocates a corresponding buffer page to the page A, and acquires an IO lock on the buffer page. Meanwhile, because of an association relationship between the page A and the page B, the backend 2 also needs to load the page B into the buffer pool, and therefore, an IO lock needs to be acquired on the buffer page corresponding to the page B. In this case, the backend 1 holds the IO lock on the buffer page corresponding to the page B, and requests to acquire an IO lock on the buffer page corresponding to the page A, meanwhile, the backend 2 holds the IO lock on the buffer page corresponding to the page A, and requests to acquire an IO lock on the buffer page corresponding to the page B, resulting in a deadlock between the backend 1 and the backend 2.

To avoid the foregoing deadlock, in embodiments of the present application, when an IO lock needs to be acquired on a buffer page in a buffer page group, the IO lock is acquired in ascending order of pages corresponding to buffer pages. In the foregoing example, the backend 1 and the backend 2 both acquire an IO lock on the buffer page corresponding to the page A first, and then acquire an IO lock on the buffer page corresponding to the page B. The backend 1 first allocates a corresponding buffer page to the page B, and acquires an IO lock on the buffer page. When requesting to acquire an IO lock on the buffer page corresponding to the page A, the backend 1 first releases the held IO lock on the buffer page corresponding to the page B, so that lock acquisition is performed in a sequence of the page A first and then the page B. In this way, when the backend 1 releases the IO lock on the buffer page corresponding to the page B, the backend 2 has an opportunity to acquire an IO lock on the buffer page corresponding to the page B, so that the backend 2 can acquire IO locks on both the page A and the page B, so as to load the page A and the page B from the disk into the buffer pages. After the backend 2 completes loading and releases the IO locks, the backend 1 finds that the page A and the page B have been loaded, and can directly read the page A and the page B from the buffer pages. This ensures that a deadlock does not occur on IO paths of the backend 1 and the backend 2.

During data loading, in addition to lock acquisition and state marking before reading data from the disk into a buffer page, after the data is read from the disk into the buffer page, lock releasing and state marking also need to be performed to complete the loading. Different from that in the acquisition of the IO locks, during the releasing of the IO locks, the IO locks of the plurality of buffer pages in the third buffer page group are sequentially released in a reverse sequence of the pages corresponding to the plurality of buffer pages in the third buffer page group. To be specific, the IO locks are released based on a sequence of the page B followed by the page A, to ensure atomic load in a page group. To be specific, all pages in a same page group are loaded to a buffer pool together, to ensure that lock acquisition, state marking, and the like on pages in the same page group are all valid.

Still refer to FIG. 4 for descriptions. It is assumed that both the backend 1 and the backend 2 need to load the page A and the page B. The backend 1 first obtains the IO locks on the two buffer pages corresponding to the page A and the page B. Because the IO locks are acquired in the sequence of the page A first and then the page B, the backend 2 is waiting for the IO lock on the buffer page corresponding to the page A. After reading the file system, the backend 1 loads data in the page A and the page B from the disk into the corresponding buffer pages. If the backend 1 releases, in the sequence of the page A first and then the page B, the IO locks on the corresponding buffer pages and performs corresponding state marking, after the IO lock on the buffer page corresponding to the page A is released and the corresponding state marking is performed, the backend 2 wakes up from waiting. When it is determined that the page A has been loaded, the backend 2 considers that the entire page group has been loaded, and then returns a buffer page address of the page B to an upper layer. However, at the moment, the backend 1 may still be releasing the IO lock on the buffer page corresponding to the page B and performing state marking, in other words, the page B has not been fully loaded, and this causes an error.

To avoid the foregoing situation, in embodiments of the present application, the IO locks are released and the state marking is performed based on a sequence of the page B first and then the page A. After loading the data in the page A and the page B from the disk into the corresponding buffer pages, the backend 1 first releases the IO lock on the buffer page corresponding to the page B and performs corresponding state marking, and then releases the IO lock on the buffer page corresponding to the page A and performs corresponding state marking. After the IO lock on the buffer page corresponding to the page A is released, the backend 2 wakes up from waiting. In this case, both the page B and the page A have been fully loaded, and the backend 2 returns the buffer page address of the page B to the upper layer without causing an error.

In addition to data loading, lock acquisition and lock releasing are also performed during data eviction. For example, in the embodiment shown in FIG. 3 in which data in the plurality of buffer pages in the first buffer page group is evicted into the disk, before the data in the plurality of buffer pages in the first buffer page group is compressed and then written into the disk, IO locks are sequentially acquired on the plurality of buffer pages in a sequence of pages corresponding to the plurality of buffer pages in the first buffer page group. After the data in the plurality of buffer pages in the first buffer page group is compressed and then written into the disk, the IO locks on the plurality of buffer pages are sequentially released in a reverse sequence of the pages corresponding to the plurality of buffer pages in the first buffer page group. Implementation principles of the acquisition of the IO locks in the sequence of the pages corresponding to the plurality of buffer pages and the releasing of the IO locks in the reverse sequence of the pages corresponding to the plurality of buffer pages are similar to those in the foregoing embodiments, and details are not described herein again.

After the data in the plurality of buffer pages in the first buffer page group is compressed and then written into the disk, and the IO locks on the plurality of buffer pages are released, for each buffer page, an exclusive lock is acquired on the buffer page in a buffer table of the buffer pool in the sequence of the pages corresponding to the plurality of buffer pages in the first buffer page group. When the exclusive lock is successfully acquired, a spinlock is acquired on buffer description information of the buffer page. When the spinlock is successfully acquired, whether the buffer page is a dirty page is determined. If none of the plurality of buffer pages in the first buffer page group is a dirty page, the buffer description information of the plurality of buffer pages in the first buffer page group is deleted, the spinlocks on the plurality of buffer pages in the first buffer page group are released, records related to the plurality of buffer pages in the first buffer page group are deleted from the buffer table, and the exclusive locks on the plurality of buffer pages in the first buffer page group are released. If an exclusive lock or a spinlock fails to be acquired on any buffer page in the first buffer page group, a second buffer page group is determined in the buffer pool of the database, where the second buffer page group includes a plurality of buffer pages. Data in the plurality of buffer pages in the second buffer page group is compressed and then written into the disk.

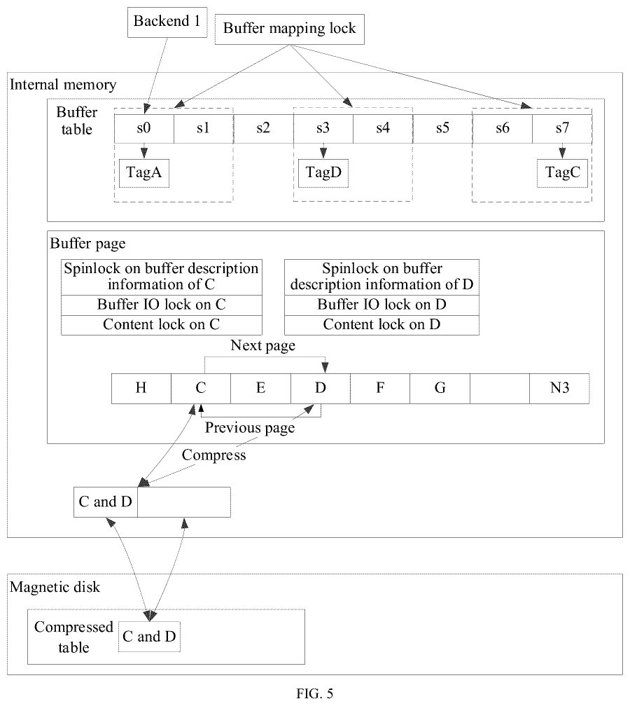

Descriptions are provided below with reference to FIG. 5. It is assumed that a backend 1 needs to read a page A, and there is no buffer page corresponding to the page A in a buffer pool. In this case, the backend 1 needs to load the page A in a disk into a buffer page. It is assumed that, as shown in FIG. 5, all buffer pages in the buffer pool are occupied. In this case, data of a buffer page needs to be evicted from the buffer pool into the disk, to allocate a buffer page to the page A. It is assumed that, according to an eviction algorithm, a buffer page corresponding to a page C is determined to be an eviction page (victim), and the buffer page corresponding to the page C needs to be evicted into the disk. The page C and a page D are sibling pages in a same page group, the page C is a previous page, and the page D is a next page. Two buffer pages corresponding to the page C and the page D are the first buffer page group in the foregoing embodiments, two buffer pages corresponding to the page C are third buffer pages, and a buffer page corresponding to the page D is a fourth buffer page. In this case, in addition to the buffer page corresponding to the page C, the buffer page corresponding to the page D also needs to be evicted into the disk. Content locks (content locks) and IO locks are acquired on the two buffer pages corresponding to the page C and the page D in a sequence of the page C first and then the page D. Data in the two buffer pages corresponding to the page C and the page D is compressed and then written into the disk, and the content locks and the IO locks on the two buffer pages corresponding to the page C and the page D are released in a sequence of the page D first and then the page C. In a buffer table, exclusive locks, that is, buffer mapping locks, are respectively acquired on a region in which the buffer page corresponding to the page A is located and a region in which the buffer page corresponding to the page C is located. The regions are shown by dashed line boxes in the figure. Records related to a page identifier and a location of the buffer page corresponding to the page A are inserted into the buffer table, and then a spinlock (BufferDesc Spinlock) is acquired on buffer description information of the buffer page corresponding to the page C. Whether the buffer page corresponding to the page C is a dirty page, in other words, whether the buffer page is re-dirtied (redirty), is determined based on the buffer description information. If the buffer page corresponding to the page C is a dirty page, a buffer page needs to be re-selected as an eviction page according to the eviction algorithm. If the buffer page corresponding to the page C is not a dirty page, an exclusive lock continues to be tentatively acquired on the buffer page corresponding to the page D in the buffer table. If the exclusive lock fails to be acquired, a buffer page needs to be re-selected as an eviction page according to the eviction algorithm. If the exclusive lock is successfully acquired, a spinlock continues to be tentatively acquired on buffer description information of the buffer page corresponding to the page D. If the spinlock fails to be acquired, a buffer page needs to be re-selected as an eviction page according to the eviction algorithm. If the spinlock is successfully acquired, whether the buffer page corresponding to the page D is a dirty page, in other words, whether the buffer page is re-dirtied, is determined based on the buffer description information. If the buffer page corresponding to the page D is a dirty page, a buffer page needs to be re-selected as an eviction page according to the eviction algorithm. If the buffer page corresponding to the page D is not a dirty page, the buffer description information of the two buffer pages corresponding to the page C and the page D is deleted, the spinlocks on the two buffer pages corresponding to the page C and the page D are released, records related to the two buffer pages corresponding to the page C and the page D are deleted from the buffer table, and the exclusive locks on the respective regions in which the two buffer pages corresponding to the page C and the page D are located are released. In this embodiment, when a buffer page is re-selected as an eviction page according to the eviction algorithm, if the eviction page belongs to a second buffer page group, a plurality of buffer pages in the second buffer page group all need to be evicted into the disk, and a process is similar to that in this embodiment.

According to embodiments, atomic eviction of a buffer page group is achieved. To be specific, a plurality of buffer pages belonging to a same buffer page group are evicted together from the buffer pool. This includes writing data in a buffer page into the disk, and clearing buffer description information, a related record in a buffer table, and the like. In addition, when a plurality of pages are evicted, locks on the plurality of pages need to be held simultaneously. This may lead to lock waiting. In terms of performance, in embodiments of the present application, a tentative lock acquisition strategy is used. To be specific, a strategy of giving up if lock acquisition fails is used, to avoid a deadlock or holding a lock for a long time period, and to prevent blocking another process from accessing a page.

In addition, it should be further noted that, in embodiments of the present application, for a table that requires a high compression ratio, a buffer page group approach may be used to increase a compression ratio, and for a table that requires high performance, a single buffer page processing strategy is still used. Optionally, in response to a third database operation instruction, a fifth buffer page is determined in the buffer pool. Data in the fifth buffer page is compressed and then written into the disk. Optionally, in response to a fourth database operation instruction, a sixth buffer page is determined in the buffer pool. Data that is in the disk and that is of a page corresponding to the fourth database operation instruction is decompressed and then loaded into the sixth buffer page. In this way, both a high compression ratio and high performance are achieved by using a single buffer pool.

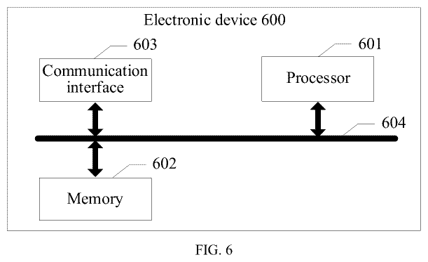

FIG. 6 is a schematic block diagram of an electronic device according to an embodiment of the present application. As shown in FIG. 6, the electronic device 600 may include at least one processor 601, configured to implement the data processing method provided in embodiments of the present application.

Optionally, the electronic device 600 further includes at least one memory 602, configured to store program instructions and/or data. The memory 602 is coupled to the processor 601. The coupling in embodiments of the present application may be an indirect coupling or a communication connection between apparatuses, units, or modules in an electrical form, a mechanical form, or another form, and is used for information exchange between the apparatuses, the units, or the modules. The processor 601 may cooperate with the memory 602. The processor 601 may execute the program instructions stored in the memory 602. At least one of the at least one memory may be included in the processor.

Optionally, the electronic device 600 further includes a communication interface 603, configured to communicate with another device through a transmission medium, so that the electronic device 600 can communicate with another device. The communication interface 603 may be, for example, a transceiver, an interface, a bus, a circuit, or an apparatus that can implement a transceiver function. The processor 601 may receive and send data and/or information through the communication interface 603, and is configured to implement the method provided in embodiments of the present application. For details, reference may be made to the detailed descriptions in the foregoing embodiments. Details are not described herein again.

A specific connection medium between the processor 601, the memory 602, and the communication interface 603 is not limited in the embodiment of the present application. In the embodiment of the present application, in FIG. 6, the processor 601, the memory 602, and the communication interface 603 are connected to each other through a bus 604. The bus 604 is represented by using a bold line in FIG. 6. A connection manner between other components is merely an example and is not intended to be limited to this. The bus may include an address bus, a data bus, a control bus, and the like. For ease of representation, only one bold line is used for representation in FIG. 6, but this does not mean that there is only one bus or only one type of bus.

It should be understood that, in embodiments of the present application, the processor may be an integrated circuit chip and has a signal processing capability. During implementation, the steps in the foregoing method embodiments may be completed by an integrated logic circuit of hardware in the processor or by instructions in a form of software. The processor may be a general-purpose processor, a digital signal processor (digital signal processor, DSP), an application specific integrated circuit (application specific integrated circuit, ASIC), a field programmable gate array (field programmable gate array, FPGA) or another programmable logic device, a discrete gate or a transistor logic device, or a discrete hardware component. The processor may implement or perform the methods, steps, and logic block diagrams that are disclosed in embodiments of the present application. The general-purpose processor may be a microprocessor, or the processor may be any conventional processor or the like. The steps of the method disclosed with reference to embodiments of the present application may be directly performed and completed by a hardware decoding processor, or may be performed and completed by a combination of hardware and software modules in the decoding processor. The software module may be located in a storage medium that is mature in the art, for example, a random access memory, a flash memory, a read-only memory, a programmable read-only memory, an electrically erasable programmable memory, or a register. The storage medium is located in the memory. The processor reads information in the memory and completes the steps of the method in combination with hardware thereof.

It should be further understood that, in embodiments of the present application, the memory may be a volatile memory or a non-volatile memory, or may include both a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache. Through illustrative but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM). It should be noted that the memories of the system and method described herein are intended to include but are not limited to these memories and any other suitable types of memories.

The present application further provides a computer-readable storage medium. The computer-readable storage medium stores a computer program (which may also be referred to as code or instructions). When the computer program is run, a computer is enabled to perform the method according to any one of the foregoing embodiments.

Terms such as “unit”, “module”, and the like used in this specification are used to indicate computer-related entities, hardware, firmware, combinations of hardware and software, software, or software being executed.

A person of ordinary skill in the art may be aware that various illustrative logical blocks (illustrative logical blocks) and steps (steps) described with reference to embodiments disclosed in this specification can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application. In the several embodiments provided in the present application, it should be understood that the disclosed apparatus, device and method may be implemented in other manners. For example, the described apparatus embodiment is merely an example. For example, division into the units is merely logical function division and may use other division manners during actual implementations. For example, a plurality of units or components may be combined, or may be integrated into another system, or some features may be omitted or not performed. In addition, the displayed or discussed mutual couplings or direct couplings or communication connections may be implemented through some interfaces. The indirect couplings or communication connections between the apparatuses or units may be implemented in an electrical form, a mechanical form, or another form.

The units described as separate components may or may not be physically separated, and components displayed as units may or may not be physical units, in other words, may be located in one position, or may be distributed on a plurality of network units. Some or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

In the foregoing embodiments, all or some of functions of the functional units may be implemented by software, hardware, firmware, or any combination thereof. When software is used to implement the foregoing embodiments, all or some of the foregoing embodiments may be implemented in a form of a computer program product. The computer program product includes one or more computer instructions (programs). When the computer program instructions (programs) are loaded and executed on a computer, all or some of procedures or functions according to embodiments of the present application are generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired manner (for example, via a coaxial cable, an optical fiber, or a digital subscriber line (digital subscriber line, DSL)) or in a wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

When functions are implemented in the form of a software functional unit and sold or used as an independent product, the functions may be stored in a computer-readable storage medium. Based on such an understanding, the technical solutions of the present application essentially, or a part contributing to conventional technologies, or some of the technical solutions may be implemented in a form of a software product. The computer software product is stored in a storage medium and includes several instructions for instructing a computer device (which may be a personal computer, a server, a network device, or the like) to perform all or some of the steps of the method described in embodiments of the present application. The foregoing storage medium includes any medium that can store program code, for example, a USB flash drive, a removable hard disk, a ROM, a RAM, a disk, or an optical disc.

The foregoing descriptions are merely specific implementations of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

1. A data processing method, comprising:
in response to a first database operation instruction, determining a first buffer page group in a buffer pool of a database, wherein the first buffer page group comprises a plurality of associated buffer pages; and
compressing data in the plurality of buffer pages in the first buffer page group, and writing the compressed data into a disk.

2. The method according to claim 1, wherein before the compressing data in the plurality of buffer pages in the first buffer page group, and writing the compressed data into a disk, the method further comprises:
sequentially acquiring input/output IO locks on the plurality of buffer pages in a sequence of pages corresponding to the plurality of buffer pages in the first buffer page group;
wherein after the compressing data in the plurality of buffer pages in the first buffer page group, and writing the compressed data into a disk, the method further comprises:
sequentially releasing the IO locks on the plurality of buffer pages in a reverse sequence of the pages corresponding to the plurality of buffer pages in the first buffer page group.

3. The method according to claim 2, further comprising:
for each buffer page, acquiring an exclusive lock on the buffer page in a buffer table of the buffer pool in the sequence of the pages corresponding to the plurality of buffer pages in the first buffer page group;
when the exclusive lock is successfully acquired, acquiring a spinlock on buffer description information of the buffer page; when the spinlock is successfully acquired, determining whether the buffer page is a dirty page; and if none of the plurality of buffer pages in the first buffer page group is a dirty page, deleting the buffer description information of the plurality of buffer pages in the first buffer page group, releasing the spinlocks on the plurality of buffer pages in the first buffer page group, deleting records related to the plurality of buffer pages in the first buffer page group from the buffer table, and releasing the exclusive locks on the plurality of buffer pages in the first buffer page group.

4. The method according to claim 3, further comprising:
if an exclusive lock or a spinlock fails to be acquired on any buffer page in the first buffer page group, determining a second buffer page group in the buffer pool of the database, wherein the second buffer page group comprises a plurality of buffer pages; and
compressing data in the plurality of buffer pages in the second buffer page group, and writing the compressed data into the disk.

5. The method according to claim 1, wherein the first buffer page group comprises a first buffer page and at least one second buffer page, and the determining a first buffer page group in a buffer pool of a database comprises:
determining the first buffer page in the buffer pool of the database; and
determining the second buffer page in the buffer pool of the database based on an association relationship between the first buffer page and the second buffer page.

6. The method according to claim 1, further comprising:
in response to a second database operation instruction, determining a third buffer page group in the buffer pool, wherein the third buffer page group comprises a plurality of associated buffer pages; and
decompressing data that is in the disk and that is of a page corresponding to the second database operation instruction, and loading the decompressed data into the plurality of buffer pages in the third buffer page group.

7. The method according to claim 6, wherein the third buffer page group comprises a third buffer page corresponding to the second database operation instruction and at least one fourth buffer page associated with the third buffer page;
the determining a third buffer page group in the buffer pool comprises:
determining the third buffer page in the buffer pool; and
determining the fourth buffer page in the buffer pool based on an association relationship between the third buffer page and the fourth buffer page.

8. The method according to claim 7, further comprising:
sequentially acquiring IO locks on the plurality of buffer pages in the third buffer page group in a sequence of pages corresponding to the plurality of buffer pages in the third buffer page group.

9. The method according to claim 8, wherein the sequentially acquiring IO locks on the plurality of buffer pages in the third buffer page group in a sequence of pages corresponding to the plurality of buffer pages in the third buffer page group comprises:
after determining the third buffer page in the buffer pool, acquiring an IO lock on the third buffer page; and
if a page corresponding to the third buffer page is a first page in the pages corresponding to the plurality of buffer pages in the third buffer page group, after determining the fourth buffer page in the buffer pool, continuing to acquire an IO lock on the fourth buffer page based on a sequence of a page corresponding to the fourth buffer page; or
if a page corresponding to the third buffer page is not a first page in the pages corresponding to the plurality of buffer pages in the third buffer page group, releasing the IO lock on the third buffer page, and after determining the fourth buffer page in the buffer pool, sequentially acquiring the IO locks on the plurality of buffer pages in the third buffer page group in the sequence of the pages corresponding to the plurality of buffer pages in the third buffer page group.

10. The method according to claim 8, wherein after the decompressing data that is in the disk and that is of a page corresponding to the second database operation instruction, and loading the decompressed data into the plurality of buffer pages in the third buffer page group, the method further comprises:
sequentially releasing the IO locks on the plurality of buffer pages in the third buffer page group in a reverse sequence of the pages corresponding to the plurality of buffer pages in the third buffer page group.

11. The method according to claim 1, further comprising:
in response to a third database operation instruction, determining a fifth buffer page in the buffer pool; and
compressing data in the fifth buffer page, and writing the compressed data into the disk.

12. The method according to claim 11, further comprising:
in response to a fourth database operation instruction, determining a sixth buffer page in the buffer pool; and
decompressing data that is in the disk and that is of a page corresponding to the fourth database operation instruction, and loading the decompressed data into the sixth buffer page.

13. An electronic device, comprising a memory and a processor, wherein
the memory is configured to store a computer program; and
the processor is configured to execute the computer program stored in the memory, and when the computer program is run, the processor is enabled to perform the following steps:
in response to a first database operation instruction, determining a first buffer page group in a buffer pool of a database, wherein the first buffer page group comprises a plurality of associated buffer pages; and
compressing data in the plurality of buffer pages in the first buffer page group, and writing the compressed data into a disk.

14. A non-transitory computer-readable storage medium, wherein the non-transitory computer-readable storage medium stores a computer program, and when the computer program is executed by a processor, the processor is enabled to perform the following steps:
in response to a first database operation instruction, determining a first buffer page group in a buffer pool of a database, wherein the first buffer page group comprises a plurality of associated buffer pages; and
compressing data in the plurality of buffer pages in the first buffer page group, and writing the compressed data into a disk.

15. The electronic device according to claim 13, wherein the processor is further enabled to perform the following steps:
before the compressing data in the plurality of buffer pages in the first buffer page group, and writing the compressed data into a disk, sequentially acquiring input/output IO locks on the plurality of buffer pages in a sequence of pages corresponding to the plurality of buffer pages in the first buffer page group; and
after the compressing data in the plurality of buffer pages in the first buffer page group, and writing the compressed data into a disk, sequentially releasing the IO locks on the plurality of buffer pages in a reverse sequence of the pages corresponding to the plurality of buffer pages in the first buffer page group.

16. The electronic device according to claim 15, wherein the processor is further enabled to perform the following steps:
for each buffer page, acquiring an exclusive lock on the buffer page in a buffer table of the buffer pool in the sequence of the pages corresponding to the plurality of buffer pages in the first buffer page group; when the exclusive lock is successfully acquired, acquiring a spinlock on buffer description information of the buffer page; when the spinlock is successfully acquired, determining whether the buffer page is a dirty page; and if none of the plurality of buffer pages in the first buffer page group is a dirty page, deleting the buffer description information of the plurality of buffer pages in the first buffer page group, releasing the spinlocks on the plurality of buffer pages in the first buffer page group, deleting records related to the plurality of buffer pages in the first buffer page group from the buffer table, and releasing the exclusive locks on the plurality of buffer pages in the first buffer page group.

17. The electronic device according to claim 16, wherein the processor is further enabled to perform the following steps:
if an exclusive lock or a spinlock fails to be acquired on any buffer page in the first buffer page group, determining a second buffer page group in the buffer pool of the database, wherein the second buffer page group comprises a plurality of buffer pages; and
compressing data in the plurality of buffer pages in the second buffer page group, and writing the compressed data into the disk.

18. The non-transitory computer-readable storage medium according to claim 14, wherein the processor is further enabled to perform the following steps:
before the compressing data in the plurality of buffer pages in the first buffer page group, and writing the compressed data into a disk, sequentially acquiring input/output IO locks on the plurality of buffer pages in a sequence of pages corresponding to the plurality of buffer pages in the first buffer page group; and
after the compressing data in the plurality of buffer pages in the first buffer page group, and writing the compressed data into a disk, sequentially releasing the IO locks on the plurality of buffer pages in a reverse sequence of the pages corresponding to the plurality of buffer pages in the first buffer page group.

19. The non-transitory computer-readable storage medium according to claim 18, wherein the processor is further enabled to perform the following steps:
for each buffer page, acquiring an exclusive lock on the buffer page in a buffer table of the buffer pool in the sequence of the pages corresponding to the plurality of buffer pages in the first buffer page group; when the exclusive lock is successfully acquired, acquiring a spinlock on buffer description information of the buffer page; when the spinlock is successfully acquired, determining whether the buffer page is a dirty page; and if none of the plurality of buffer pages in the first buffer page group is a dirty page, deleting the buffer description information of the plurality of buffer pages in the first buffer page group, releasing the spinlocks on the plurality of buffer pages in the first buffer page group, deleting records related to the plurality of buffer pages in the first buffer page group from the buffer table, and releasing the exclusive locks on the plurality of buffer pages in the first buffer page group.

20. The non-transitory computer-readable storage medium according to claim 19, wherein the processor is further enabled to perform the following steps:
if an exclusive lock or a spinlock fails to be acquired on any buffer page in the first buffer page group, determining a second buffer page group in the buffer pool of the database, wherein the second buffer page group comprises a plurality of buffer pages; and
compressing data in the plurality of buffer pages in the second buffer page group, and writing the compressed data into the disk.
